(19) United States
(12) Patent Application Publication
(10) Pub. No.: US 2026/0011066 A1
(43) Pub. Date: Jan. 8, 2026

(54) ELECTRONIC DEVICE AND METHOD FOR DISPLAYING THREE-DIMENSIONAL IMAGE

(71) Applicant: SAMSUNG ELECTRONICS CO., LTD., Suwon-si (KR)

(72) Inventors: Jongkwang KIM, Suwon-si (KR); Kyuwon KIM, Suwon-si (KR); Jongkyu KIM, Suwon-si (KR); Hyunsoo KIM, Suwon-si (KR); Chulju YANG, Suwon-si (KR)

(73) Assignee: SAMSUNG ELECTRONICS CO., LTD., Suwon-si (KR)

(21) Appl. No.: 19/264,376

(22) Filed: Jul. 9, 2025

Related U.S. Application Data
(63) Continuation of application No. PCT/KR2025/009393, filed on Jul. 2, 2025.

(30) Foreign Application Priority Data
Jul. 5, 2024 (KR) 10-2024-0089166
Jul. 8, 2024 (KR) 10-2024-0089828

(51) Int. Cl. G06T 15/00; G06T 7/20; G06T 7/70; G06V 20/50; G06V 40/10

(52) U.S. Cl. CPC G06T 15/00; G06T 7/20; G06T 7/70; G06V 20/50; G06V 40/10; G06T 2200/04; G06T 2207/10021; G06T 2207/30201; G06T 2207/30241

(57) ABSTRACT

An electronic device according to an embodiment of the disclosure may include: a display; at least one processor; and at least one memory configured to store instructions, wherein the instructions, when executed individually or collectively by the at least one processor, cause the electronic device to: identify a specific object in an image; identify at least one movement point of a virtual camera, based on a position of the specific object; identify a movement trajectory, based on the at least one movement point; capture a video, based on the movement trajectory; and display the video on the display and/or store the video in the at least one memory.

### CROSS-REFERENCE TO RELATED APPLICATION(S)

This application is a continuation of International Application No. PCT/KR2025/009393 designating the United States, filed on Jul. 2, 2025, in the Korean Intellectual Property Receiving Office and claiming priority to Korean Patent Application No. 10-2024-0089166, filed on Jul. 5, 2024, and Korean Patent Application No. 10-2024-0089828, filed on Jul. 8, 2024, the disclosures of each of which are incorporated by reference herein in their entireties.

### BACKGROUND

### 1. Field

One or more example embodiments of the disclosure relate to an electronic device and a three-dimensional image display method.

### 2. Description of Related Art

In general, an electronic device may convert a two-dimensional (hereinafter, 2D) image into a three-dimensional (hereinafter, 3D) image and provide the 3D image to a user. For example, the electronic device may identify depth information of an image, based on a 2D image, and convert the depth information into a 3D mesh to generate a volumetric 3D image. Through the 3D image generated by the electronic device by converting the 2D image, user experience can be enhanced.

The above-described information may be provided as related art for the purpose of assisting in understanding the disclosure. No assertion or decision is made as to whether any of the above might be applicable as prior art with regard to the disclosure.

When an electronic device displays a three-dimensional (3D) image generated by converting a two-dimensional (2D) image, if the 3D image is statically displayed or a 3D effect is not well expressed, there is a problem that a user does not perceive a difference between the 2D image and the 3D image.

### SUMMARY

An aspect of an electronic device and a three-dimensional image display method according to an embodiment of the disclosure is to display a three-dimensional (3D) image, generated based on a two-dimensional (2D) image, as an image captured in a virtual space.

An aspect of an electronic device and a three-dimensional image display method according to an embodiment of the disclosure is to display a 3D image, generated based on a 2D image, as an image and/or a video captured in a virtual space.

An electronic device according to an embodiment of the disclosure may include a display.

The electronic device according to an embodiment of the disclosure may include at least one processor.

The electronic device according to an embodiment of the disclosure may include at least one memory configured to store instructions.

The instructions according to an embodiment of the disclosure, when executed individually or collectively by the at least one processor, may cause the electronic device to identify a specific object in an image.

The instructions according to an embodiment of the disclosure, when executed individually or collectively by the at least one processor, may cause the electronic device to identify at least one movement point of a virtual camera, based on a position of the specific object.

The instructions according to an embodiment of the disclosure, when executed individually or collectively by the at least one processor, may cause the electronic device to identify a movement trajectory, based on the at least one movement point.

The instructions according to an embodiment of the disclosure, when executed individually or collectively by the at least one processor, may cause the electronic device to capture a three-dimensional (3D) video, based on the movement trajectory, and display the 3D video on the display and/or store the 3D video in the at least one memory.

A 3D image display method of an electronic device according to an embodiment of the disclosure may include an operation of identifying a specific object in an image.

The 3D image display method of the electronic device according to an embodiment of the disclosure may include an operation of identifying at least one movement point of a virtual camera, based on a position of the specific object.

The 3D image display method of the electronic device according to an embodiment of the disclosure may include an operation of identifying a movement trajectory, based on the at least one movement point.

The 3D image display method of the electronic device according to an embodiment of the disclosure may include an operation of capturing a video, based on the movement trajectory.

The 3D image display method of the electronic device according to an embodiment of the disclosure may include an operation of displaying the video on the display and/or storing the video in at least one memory.

### BRIEF DESCRIPTION OF DRAWINGS

In relation to the description of drawings, the same or similar reference numerals may be used for the same or similar components.

FIG. 1 is a block diagram of an example of an electronic device capable of performing operations described in the disclosure.

FIG. 2 is a diagram illustrating a three-dimensional (3D) video program according to an embodiment of the disclosure.

FIG. 3 is a flowchart illustrating a three-dimensional image display method according to an embodiment of the disclosure.

FIG. 4 is a diagram illustrating a method for recognizing a specific object in an image by an electronic device according to an embodiment of the disclosure.

FIG. 5 is a diagram illustrating a method for recognizing a specific object in an image by an electronic device according to an embodiment of the disclosure.

FIG. 6 is a diagram illustrating a method for recognizing a specific object in an image by an electronic device according to an embodiment of the disclosure.

FIG. 7 is a diagram illustrating a method for recognizing a face of a specific object in an image and detecting a gaze by an electronic device according to an embodiment of the disclosure.

FIG. 8 is a diagram illustrating a method for recognizing a face of a specific object in an image and detecting a gaze by an electronic device according to an embodiment of the disclosure.

FIG. 9 is a diagram illustrating a method for identifying a start point and an end point by an electronic device according to an embodiment of the disclosure.

FIG. 10 is a diagram illustrating a method for identifying a start point by an electronic device according to an embodiment of the disclosure.

FIG. 11 is a diagram illustrating a method for identifying an end point by an electronic device according to an embodiment of the disclosure.

FIG. 12 is a diagram illustrating a method for identifying a passing point by an electronic device based on a start point and an end point according to an embodiment of the disclosure.

FIG. 13 is a diagram illustrating a method for identifying a start point and an end point by an electronic device when a specific object does not include a face according to an embodiment of the disclosure.

FIG. 14 is a diagram illustrating a case where multiple specific objects are included in an image according to an embodiment of the disclosure.

FIG. 15 is a diagram illustrating a method for identifying a start point, a passing point, and an end point in FIG. 14 by an electronic device according to an embodiment of the disclosure.

FIG. 16 is a diagram illustrating a method for identifying a movement trajectory by an electronic device according to an embodiment of the disclosure.

FIG. 17 is a diagram illustrating a method for identifying movement trajectories by an electronic device when multiple specific objects are included in an image according to an embodiment of the disclosure.

FIG. 18 is a diagram illustrating a direction of a virtual camera when an electronic device captures a specific object of an image along a movement trajectory according to an embodiment of the disclosure.

FIG. 19 is a diagram schematically illustrating a movement time of a virtual camera between movement points according to an embodiment of the disclosure.

FIG. 20 is a diagram illustrating a method for capturing a 3D video by an electronic device, with a Glambot capturing effect for a specific object included in an image, according to an embodiment of the disclosure.

FIG. 21 is a diagram illustrating a user interface in which a position movement and a zoom effect of a movement point are changeable according to a user input according to an embodiment of the disclosure.

### DETAILED DESCRIPTION

Hereinafter, with reference to the accompanying drawings, various example embodiments of the disclosure are described in detail and thus a person of ordinary skill in the art to which the disclosure belongs can easily practice the disclosure. The disclosure may be implemented in many different forms and is not limited to the embodiments described herein.

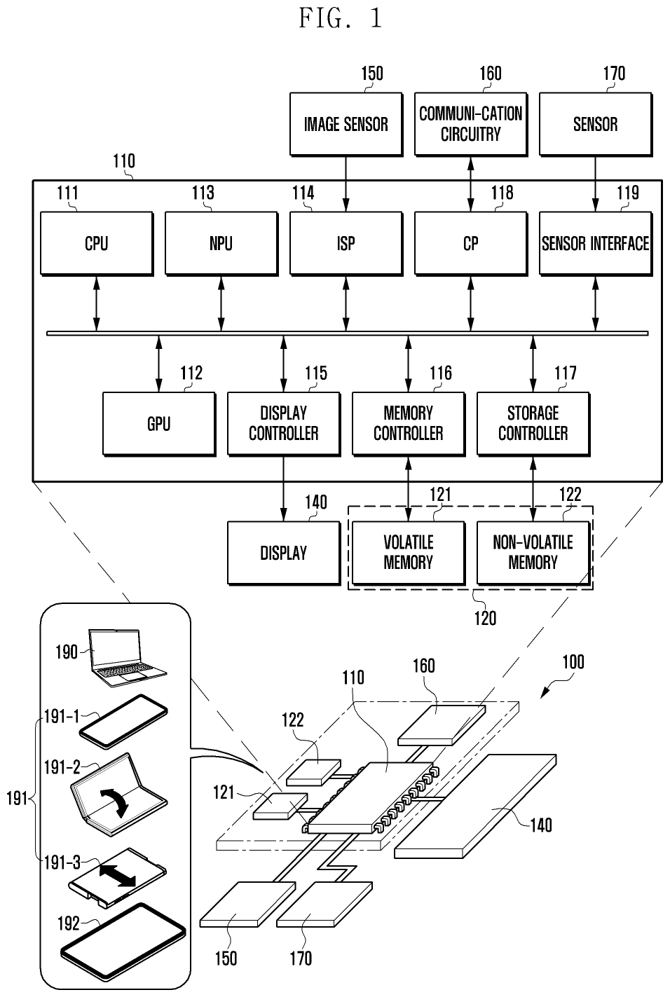

FIG. 1 illustrates a block diagram of an example electronic device 100 capable of performing the operations described herein.

Referring to FIG. 1, the electronic device 100 may be one of various types of electronic devices, such as a notebook computer 190, smartphones 191 having various form factors (e.g., a bar-type smartphone 191-1, a foldable smartphone 191-2, or a slidable (or rollable) smartphone 191-3), a tablet PC 192, a cellular telephone (not shown), and any other similar computing devices (not shown). The components illustrated in FIG. 1, the relationships thereof, and the functions thereof are merely for illustration, and are not intended to limit the implementations described or claimed in the disclosure thereto. The electronic device 100 may be referred to as a mobile device, a user equipment, a multifunctional device, a portable device, or a server.

The electronic device 100 may comprise various components including at least one processor 110 (hereinafter, the processor 110), at least one memory 120 (hereinafter, the memory 120), at least one display 140 (hereinafter, the display 140), at least one image sensor 150 (hereinafter, the image sensor 150), at least one communication circuitry 160 (hereinafter, the communication circuitry 160), and/or at least one sensor 170 (hereinafter, the sensor 170). The aforementioned components are merely of an example. For example, the electronic device 100 may comprise other components (e.g., a power management integrated circuitry (PMIC), an audio processing circuitry, an antenna, a rechargeable battery, or an input/output interface). For example, some components may be omitted from the electronic device (100). For example, some components may be integrated into one component.

The processor 110 may be implemented as one or more integrated circuit (or circuitry) (IC) chips and may perform various data processing. The processor 110 may include at least one electrical circuitry and may process instructions (or program, data, and so on) stored in the memory 120 individually or collectively in a distributed manner. The processor 110 may include a processor assembly that includes one or more processing circuitries. The processor may include any processing circuitry that may be operative for controlling operations and performance of one or more components (e.g., the memory 120, a display 140, the image sensor 150, the communication circuitry 160, and/or the sensor 170) of the electronic device. For example, the processor 110 (e.g., an application processor (AP)) may be implemented as a system on chip (SoC) (e.g., one chip or chipset). For example, the processor 110 may be implemented as a plurality of cores (or at least one core circuitry), a plurality of chips, or a plurality of chipsets. For example, the processor 110 may comprise one or more processing circuitry. For example, the processor 110 may comprise one or more processing circuitry which are individually and/or collectively configured to perform various functions of the present disclosure. As a non-limiting example, at least a portion of the processor 110 may be included in a first chip of the electronic device 100 and at least another portion of the processor 110 may be included in a second chip of the electronic device 100 different from the first chip of the electronic device 100.

For example, the processor 110 may comprise a central processing unit (CPU) 111, a graphics processing unit (GPU) 112, a neural processing unit (NPU) 113, an image signal processor (ISP) 114, a display controller 115, a memory controller 116, a storage controller 117, a communication processor (CP) 118, and/or a sensor interface 119. These components of the processor 110 are merely of an example. For example, the processor 110 may further comprise other components. For example, some components of the processor 110 may be omitted from the processor 110. For example, some components of the processor 110 may be included as separate components of the electronic device 100 outside the processor 110. For example, some components of the processor 110 (e.g., the memory controller 116) may be included in other components of the electronic device 100 (e.g., at least a portion of the memory 120, an interface (e.g., usable for connecting to at least one component of the electronic device 100), the display 140, and/or the image sensor 150).

The processor 110 may cause other components of the electronic device 100 to perform various operations by executing instructions stored in the memory 120. The CPU 111 (or a central processing circuitry) may be configured to control the components of the processor 110 based on execution of instructions stored in the memory 120 (e.g., the volatile memory 121 and/or the non-volatile memory 122). The GPU 112 (or a graphic processing circuitry) may be configured to execute parallel computations (e.g., rendering). The NPU 113 (or a neural processing circuitry, or an artificial intelligence (AI) chip) may be configured to execute operations (e.g., convolution computations) for an artificial intelligence model. The ISP 114 (or an image signal processing circuitry) may be configured to process a raw image obtained from the image sensor 150 in a format suitable for a component in the electronic device 100 or a component of the processor 110. The display controller 115 (or a display control circuitry, or a display processing unit (DPU)) may be configured to process an image obtained from the CPU 111, the GPU 112, the ISP 114, or the memory 120 (e.g., the volatile memory 121) in a format suitable for the display 140. The memory controller 116 (or a memory control circuitry) may be configured to control reading data from the volatile memory 121 and writing data to the volatile memory 121. The storage controller 117 (or a storage control circuitry) may be configured to control reading data from the non-volatile memory 122 and writing data to the non-volatile memory 122. The CP 118 (or a communication processing circuitry) may be configured to process data obtained from a component of the processor 110 in a format suitable for transmission to another electronic device via the communication circuitry 160, or to process data obtained from another electronic device via the communication circuitry 160 in a format suitable for processing of the component of the processor 110. For example, the communication circuitry 160 may comprise one or more communication circuitry. The sensor interface 119 (or a sensing data processing circuitry, a sensor hub) may be configured to process data on a state of the electronic device 100 and/or a state around the electronic device 100, obtained through the sensor 170, in a format suitable for a component of the processor 110.

The memory 120 may comprise one or more storage mediums (or one or more storage devices). For example, the memory 120 may include a memory assembly that includes one or more storage mediums. For example, the one or more storage mediums may comprise a permanent memory (e.g., the non-volatile memory 122) such as a hard drive, a flash memory, a read-only memory (ROM), a semi-permanent memory (e.g., the volatile memory 121) such as a random access memory (RAM), a storage (or a storage assembly) of any other suitable type, or any combination thereof. The memory 120 may comprise a cache memory which is a memory of one or more different types used to store data for performing a function or feature of the electronic device 100 at least temporarily. As a non-limiting example, the cache memory may be included in the processor 110. The memory 120 may be fixedly embedded within the electronic device 100, or may be incorporated onto one or more suitable types of components that may be repeatedly inserted into the electronic device 100, and removed from the electronic device 100 (e.g., a subscriber identity module (SIM) card, and/or a secure digital (SD) card).

For example, the memory 120 may store one or more software applications such as an operating system (or a system) software application, a firmware software application, a driver software application, a plug-in (e.g., add-in, add-on, and/or applet) software application, and/or any other suitable software application. For example, the one or more software applications may include instructions executable by the processor 110. For example, the memory 120 may store instructions callable by an application programming interface (API). For example, the memory 120 may store instructions in a library.

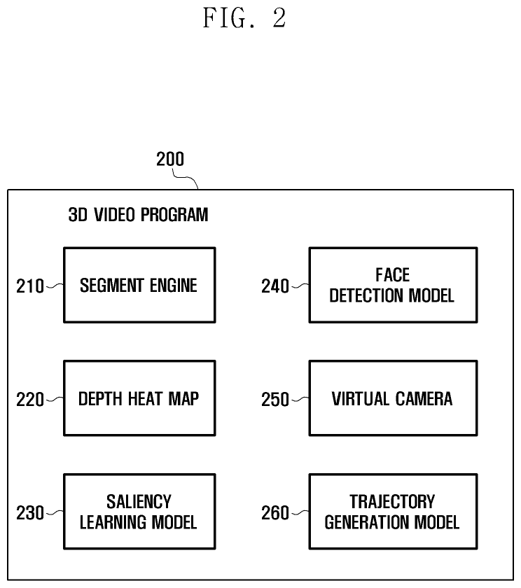

FIG. 2 is a diagram illustrating a three-dimensional (3D) video program 200 according to an embodiment of the disclosure.

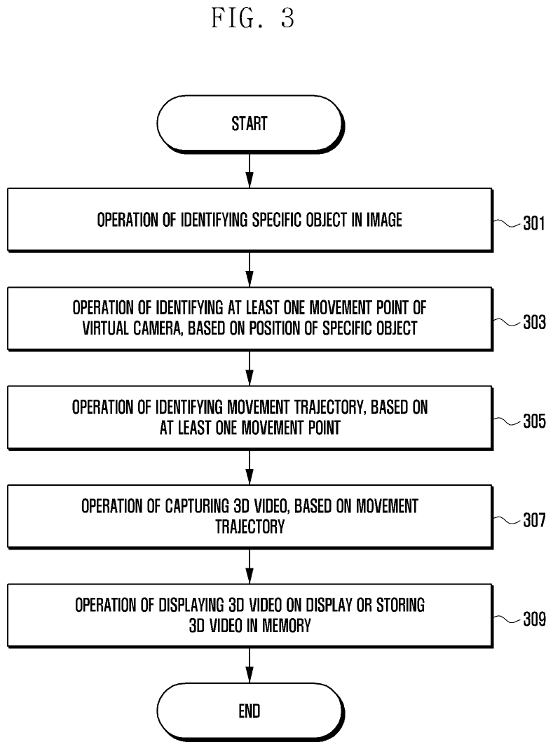

In an embodiment, the electronic device 100 may include the 3D video program 200. The processor 110 of FIG. 1 may store the 3D video program 200. The memory 120 of FIG. 1 may store the 3D video program 200. The 3D video program 200 stored in the memory 120, when executed by the processor 110, may cause the electronic device 100 (or the processor 110) to perform a three-dimensional image display method (e.g., a three-dimensional image display method of FIG. 3 that will be described later).

In an embodiment, the three-dimensional (3D) video program 200 may include a segment engine 210, a depth heat map 220, a saliency learning model 230, a face detection model 240, a virtual camera 250, and/or a trajectory generation model 260.

In an embodiment, each of the segment engine 210, the depth heat map 220, the saliency learning model 230, the face detection model 240, the virtual camera 250, and the trajectory generation model 260 may be based on artificial intelligence (e.g., generative artificial intelligence (AI)).

In an embodiment, the segment engine 210, the depth heat map 220, the saliency learning model 230, the face detection model 240, the virtual camera 250, and the trajectory generation model 260 may be based on one artificial intelligence (e.g., generative AI).

In an embodiment, an artificial intelligence-based (e.g., generative AI) system may perform at least some of operations of the segment engine 210, the depth heat map 220, the saliency learning model 230, the face detection model 240, the virtual camera 250, and/or the trajectory generation model 260, based on an input defined by a prompt, under control of the processor 110.

In an embodiment, the segment engine 210 may perform segmentation on an image. The electronic device 100 may recognize (or detect) and classify an object in the image by using the segment engine 210. The electronic device 100 may identify a boundary of the object included in the image by using the segment engine 210, and recognize the object.

In an embodiment, the depth heat map 220 may express a depth of a corresponding position by using a color of each pixel. The depth heat map 220 may infer and detect a distant view of a two-dimensional (2D) image and convert an object included in the 2D image into a 3D mesh, based on depth information. The depth heat map 220 may separate a foreground layer and a background layer with reference to a part having a largest change in a Z-coordinate in a transformed 3D space, and identify a layer separated as the foreground as a region of interest and/or a specific object. The depth heat map 220 may identify a foremost object in the image as a region of interest and/or a specific object based on a condition of a weight.

In an embodiment, the saliency learning model 230 may automatically detect and identify an important and/or noticeable part in an image or a video. The saliency learning model 230 may evaluate a likelihood of each pixel being noticed within the image or the video. The saliency learning model 230 may analyze information such as color, brightness, and texture around a pixel, to evaluate the likelihood of being noticed. The saliency learning model 230 may identify a region corresponding to a specific score or higher as a region of interest and/or a specific object, based on the evaluation of the likelihood of being noticed.

In an embodiment, the instructions stored in the memory 130, when executed by the at least one processor 110, may cause the electronic device 100 to identify a region of interest and/or a specific object in an image by using at least one of the segment engine 210, the depth heat map 220, or the saliency learning model 230.

In an embodiment, the instructions stored in the memory 130, when executed by the at least one processor 110, may cause the electronic device 100 to identify a region of interest and/or a specific object in the image by using the segment engine 210.

In an embodiment, the instructions stored in the memory 130, when executed by the at least one processor 110, may cause the electronic device 100 to identify a region of interest and/or a specific object in the image by using the depth heat map 220.

In an embodiment, the instructions stored in the memory 130, when executed by the at least one processor 110, may cause the electronic device 100 to identify a region of interest and/or a specific object in the image by using the saliency learning model 230.

In an embodiment, the region of interest and/or the specific object may be identified by processing of intersection regions among regions of interest and/or specific objects identified by the segment engine 210, the depth heat map 220, and/or the saliency learning model 230.

In an embodiment, the instructions stored in the memory 130, when executed by the at least one processor 110, may cause the electronic device 100 to combine weights for the intersection regions of the regions of interest and/or the specific objects identified by the segment engine 210, the depth heat map 220, and/or the saliency learning model 230, and identify a region having a highest average weight as a region of interest and/or a specific object.

In an embodiment, among the regions of interest and/or the specific objects identified by the segment engine 210, the depth heat map 220, and/or the saliency learning model 230, the instructions stored in the memory 130, when executed by the at least one processor 110, may cause the electronic device 100 to assign a different accuracy weight to the region of interest and/or the specific object identified using the segment engine 210. For example, among the regions of interest and/or the specific objects identified by the segment engine 210, the depth heat map 220, and/or the saliency learning model 230, the instructions stored in the memory 130, when executed by the at least one processor 110, may cause the electronic device 100 to assign a highest accuracy weight to the region of interest and/or the specific object identified using the segment engine 210, assign a lowest accuracy weight to the region of interest and/or the specific object identified using the saliency learning model 230, and assign an intermediate accuracy weight to the region of interest and/or the specific object identified using the depth heat map 220.

In an embodiment, the electronic device 100 may perform an operation of identifying a region of interest and/or a specific object in an image, based on a result of a region of interest learning model (e.g., the segment engine 210, the depth heat map 220, and/or the saliency learning model 230), as a condition for the identification. For example, by using the saliency learning model 230 trained for a region of interest and/or a specific object that a person emotionally perceives, the electronic device 100 may increase the accuracy of identifying the region of interest and/or the specific object and derive a result desired by a user.

In an embodiment, the instructions stored in the memory 130, when executed by the at least one processor 110, may cause the electronic device 100 to assign a different weight to each region of interest learning model (e.g., the segment engine 210, the depth heat map 220, and/or the saliency learning model 230). For example, there is no guarantee that a region of interest and/or a specific object that a person perceives and a saliency region of interest and/or a specific object identified through the saliency learning model 230 on a 3D image are represented as 3D objects, and thus, a lowest weight may be assigned to the region of interest and/or the specific object identified using the saliency learning model 230.

In an embodiment, the face detection model 240 may recognize a face in the region of interest and/or the specific object identified using the segment engine 210, the depth heat map 220, and/or the saliency learning model 230. The face may include not only a human face but also an animal face. The face detection model 240 may identify a direction of a gaze on the face.

In an embodiment, the instructions stored in the memory 130, when executed by the at least one processor 110, may cause the electronic device 100 to recognize a face in a region of interest and/or a specific object identified using the face detection model 240, and/or identify the direction of the gaze on the face.

For example, the face detection model 240 may identify a gaze through three types of position information of pitch, yaw, and roll of the face.

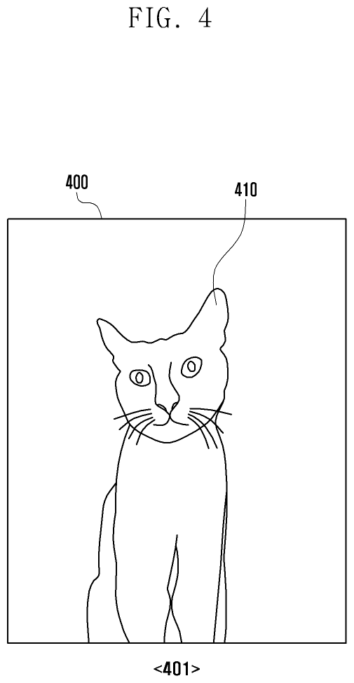

In an embodiment, X and Y axes of the virtual camera 250 may be to a point where a Z-axis of a gaze of a face in a 3D space meets the Z-axis where the virtual camera 250 is located, to thus move a position of the virtual camera 250 to a point where the gaze is directed in the 3D space, and a direction of the virtual camera 250 may be configured to make a 90-degree angle with the X and Y axes of the gaze, to cause the virtual camera 250 to face straight toward eyes of a specific object and thus cause the virtual camera 250 to move in a direction in which the specific object faces and then face straight toward the specific object. In this manner, the face detection model 240 may detect the gaze of a specific object (e.g., 410 in FIG. 4), based on a position and a direction of the virtual camera 250 facing (or making an eye contact with) the specific object.

In an embodiment, the instructions stored in the memory 130, when executed by the at least one processor 110, may cause the electronic device 100 to move the X and Y axes of the virtual camera 250 to a point where the Z-axis of the gaze of a face in the 3D space meets the Z-axis where the virtual camera 250 is located, to thus move a position of the virtual camera 250 to a point where the gaze is directed in the 3D space, and configure the direction of the virtual camera 250 to make a 90-degree angle with the X and Y axes of the gaze, to cause the virtual camera 250 to face straight toward eyes of a specific object and thus cause the virtual camera 250 to move in a direction in which the specific object faces and then face straight toward the specific object, to detect the gaze of the specific object 410, based on a position and a direction of the virtual camera 250 facing the specific object.

In an embodiment, the virtual camera 250 may freely change its position or adjust its direction within a 3D modeling environment, and may capture a specific object from various angles and/or various perspectives. The virtual camera 250 may zoom in or zoom out on an object in an image through various lens effects such as wide-angle, telephoto, and standard lenses, just like an actual camera, within the 3D modeling environment. The virtual camera 250 may automatically track a specific object within the 3D modeling environment or implement an animation that moves along a preconfigured path. The virtual camera 250 may adjust a depth of field (DOF) within the 3D modeling environment to blur the background and focus on the specific object.

In an embodiment, the instructions stored in the memory 130, when executed by the at least one processor 110, may cause the electronic device 100 to freely change a position or adjust a direction within the 3D modeling environment by using the virtual camera 250, and capture a specific object from various angles or various perspectives.

In an embodiment, the trajectory generation model 260 may identify a start point where a movement of the virtual camera 250 for 3D video generation starts, an end point where the movement of the virtual camera 250 ends, and a passing point which passes through the start point and the end point, based on the direction of the gaze identified through the face detection model 240.

In an embodiment, the trajectory generation model 260 may generate a movement trajectory of the virtual camera 250, based on the start point, the end point, and the passing point.

In an embodiment, the instructions stored in the memory 130, when executed by at least one processor 110, may cause the electronic device 100 to identify a start point where the movement of the virtual camera 250 for 3D video generation starts, an end point where the movement of the virtual camera 250 ends, and a passing point which passes through the start point and the end point, based on the direction of the gaze identified using the trajectory generation model 260.

In an embodiment, the instructions stored in the memory 130, when executed by the at least one processor 110, may cause the electronic device 100 to generate a movement trajectory of the virtual camera 250, based on the start point, the end point, and the passing point.

In an embodiment, the virtual camera 250 may generate a 3D video by capturing a region of interest and/or a specific object along the movement trajectory in the 3D modeling environment.

In an embodiment, the instructions stored in the memory 130, when executed by the at least one processor 110, may cause the electronic device 100 to generate a 3D video by capturing a region of interest and/or a specific object along the movement trajectory in the 3D modeling environment by using the virtual camera 250.

FIG. 3 is a flowchart illustrating a three-dimensional image display method according to an embodiment of the disclosure.

According to an embodiment, in operation 301, the instructions stored in the memory 120, when executed individually or collectively by the at least one processor 110, may cause the electronic device 100 to identify a specific object in an image.

In an embodiment, the image may include a photo stored in the memory 120 or a gallery application. The image may include a two-dimensional image. The electronic device 100 may obtain an image captured by a camera through the image sensor 150. The electronic device 100 may receive (e.g., download) the image through the communication circuit 150.

According to an embodiment, in operation 301, the instructions stored in the memory 120, when executed individually or collectively by the at least one processor 110, may cause the electronic device 100 to identify a specific object in an image by using at least one of the segment engine 210, the depth heat map 220, or the saliency learning model 230.

In an embodiment, the image may include one specific object. However, the disclosure is not limited thereto, and the image may include multiple specific objects.

According to an embodiment, in operation 301, the instructions stored in the memory 120, when executed individually or collectively by the at least one processor 110, may cause the electronic device 100 to identify multiple specific objects in the image by using at least one of the segment engine 210, the depth heat map 220, or the saliency learning model 230.

In an embodiment, the specific objects may include an animal or a person. However, the disclosure is not limited thereto, and the specific objects may include an inanimate object.

According to an embodiment, in operation 303, the instructions stored in the memory 120, when executed individually or collectively by the at least one processor 110, may cause the electronic device 100 to identify at least one movement point of the virtual camera 250, based on a position of the specific object including an animal or a person. The movement point may include a point where the virtual camera 250 is required to perform capturing in the 3D modeling environment in order to capture a 3D video for the specific object. The movement point may include a start point and an end point. The movement point may include the start point, a passing point, and the end point. The passing point may include multiple passing points.

According to an embodiment, in operation 303, the instructions stored in the memory 120, when executed individually or collectively by the at least one processor 110, may cause the electronic device 100 to recognize a face in the specific object, which includes the animal or the person, identified using the face detection model 240.

According to an embodiment, in operation 303, the instructions stored in the memory 120, when executed individually or collectively by the at least one processor 110, may cause the electronic device 100 to identify the direction of the gaze on the face by using the face detection model 240.

According to an embodiment, in operation 303, the instructions stored in the memory 120, when executed individually or collectively by the at least one processor 110, may cause the electronic device 100 to identify a start point where the movement of the virtual camera 250 for 3D video generation starts, an end point where the movement of the virtual camera 250 ends, and a passing point which passes through the start point and the end point, based on the direction of the gaze identified through the face detection model 240.

In an embodiment, the start point may include a gaze direction. The start point may include a position that is spaced apart from a specific object by a first specific distance or more. The end point may include a position that is rotated 180 degrees from the start point. The end point may include a direction that is opposite to the direction of the gaze. The end point may include a direction that is rotated 180 degrees relative to the direction of the gaze. The end point may include a position that is spaced apart from the specific object by a second specific distance or more. The end point may include a direction that is opposite to the start point with reference to a center point of the face.

In an embodiment, the passing point may include a position that is spaced apart from the specific object by a third specific distance or more. The passing point may include an intermediate position between the start point and the end point.

According to an embodiment, even if the specific object includes an animal or a person, if the specific object does not include a face or if the specific object is an inanimate object, in operation 303, the instructions stored in the memory 120, when executed individually or collectively by the at least one processor 110, may cause the electronic device 100 to identify the at least one movement point of the virtual camera 250, based on a position of the specific object.

According to an embodiment, even if the specific object includes an animal or a person, if the specific object does not include a face, in operation 303, the instructions stored in the memory 120, when executed individually or collectively by the at least one processor 110, may cause the electronic device 100 to identify a center of the object as the start point, and identify a center of the image as the end point.

According to an embodiment, if the specific object is an inanimate object, in operation 303, the instructions stored in the memory 120, when executed individually or collectively by the at least one processor 110, may cause the electronic device 100 to identify a specific position in a left direction of the specific object as the start point and identify a specific position in a right direction of the specific object as the end point. In this case, the passing point may include an intermediate position between the start point and the end point. However, the disclosure is not limited thereto, and if the specific object is an inanimate object, in operation 303, the instructions stored in the memory 120, when executed individually or collectively by the at least one processor 110, may cause the electronic device 100 to identify a specific position in the right direction of the specific object as the start point and identify a specific position in the left direction of the specific object as the end point. If the specific object is an inanimate object, in operation 303, the instructions stored in the memory 120, when executed individually or collectively by the at least one processor 110, may cause the electronic device 100 to identify a specific position in an upward direction of the specific object as the start point, and identify a specific position in a downward direction of the specific object as the end point. If the specific object is an inanimate object, in operation 303, the instructions stored in the memory 120, when executed individually or collectively by the at least one processor 110, may cause the electronic device 100 to identify a specific position in the downward direction of the specific object as the start point, and identify a specific position in the upward direction of the specific object as the end point.

According to an embodiment, if multiple specific objects are included in the image, in operation 303, the instructions stored in the memory 120, when executed individually or collectively by the at least one processor 110, may cause the electronic device 100 to identify a specific object on a far left as the start point, and identify a specific object on a far right as the end point. In this case, the passing point may include a specific object positioned between the start point and the end point. However, the disclosure is not limited thereto, and if the multiple specific objects are included in the image, in operation 303, the instructions stored in the memory 120, when executed individually or collectively by the at least one processor 110, may cause the electronic device 100 to identify the specific object on the far right as the start point, and identify the specific object on the far left as the end point.

According to an embodiment, if the specific object is an inanimate object, in operation 303, the instructions stored in the memory 120, when executed individually or collectively by the at least one processor 110, may cause the electronic device 100 to display, on the display 140, a user interface in which a position of a movement point is changeable by a user input.

According to an embodiment, if the specific object is an inanimate object, in operation 303, the instructions stored in the memory 120, when executed individually or collectively by the at least one processor 110, may cause the electronic device 100 to display, on the display 140, a user interface in which an order of a movement point is changeable by a user input.

According to an embodiment, if the specific object is an inanimate object, in operation 303, the instructions stored in the memory 120, when executed individually or collectively by the at least one processor 110, may cause the electronic device 100 to display, on the display 140, a user interface in which zooming in/zooming out when capturing a specific object at a movement point is changeable by a user input.

According to an embodiment, in operation 305, the instructions stored in the memory 120, when executed individually or collectively by the at least one processor 110, may cause the electronic device 100 to identify a movement trajectory, based on the at least one movement point. The movement trajectory may include a trajectory along which the virtual camera 250 moves while capturing a specific object in the 3D modeling environment. The movement trajectory may include a direction in which the virtual camera 250 captures the specific object in the 3D modeling environment. The direction in which the virtual camera 250 captures the specific object in the 3D modeling environment may always be directed toward the specific object.

In an embodiment, the movement trajectory may include a trajectory along which a movement point moves along a curve. The movement point may include the start point, the end point, and the passing point. The movement trajectory may include a Bezier curve or a cardinal spline.

In an embodiment, the movement trajectory may include a trajectory along which a movement point moves along a straight line. The movement point may include the start point and the end point. For example, even if the specific object includes an animal or a person, if the specific object does not include a face, the instructions stored in the memory 120, when executed individually or collectively by the at least one processor 110, may cause the electronic device 100 to identify the center of the object as the start point, and identify the center of the image as the end point. In this case, the passing point may not be identified, and the movement trajectory may be generated as a straight line.

In an embodiment, the virtual camera 250, which captures the specific object along the movement trajectory, may not end the capturing at the end point, but may instead circle back to the start point and capture the specific object in a cyclical manner according to the movement point.

In an embodiment, in operation 305, the instructions stored in the memory 120, when executed individually or collectively by the at least one processor 110, may cause the electronic device 100 to make a movement time between movement points of the virtual camera 250 the same or linear.

In an embodiment, in operation 305, the instructions stored in the memory 120, when executed individually or collectively by the at least one processor 110, may cause the electronic device 100 to differentially allocate the movement time between the movement points of the virtual camera 250. For example, a movement time of the virtual camera 250 between the start point and the passing point may be longer than a movement time of the virtual camera 250 between the passing point and the end point.

According to an embodiment, in operation 307, the instructions stored in the memory 120, when executed individually or collectively by the at least one processor 110, may cause the electronic device 100 to capture a video, based on the movement trajectory. The video captured based on the movement trajectory may include at least one of a 3D video or a 2D video. According to an embodiment, in operation 307, the instructions stored in the memory 120, when executed individually or collectively by the at least one processor 110, may cause the electronic device 100 to capture a 3D video, based on the movement trajectory.

According to an embodiment, when capturing the 3D video based on the movement trajectory, in operation 307, the instructions stored in the memory 120, when executed individually or collectively by the at least one processor 110, may cause the electronic device 100 to capture a video of the specific object while moving the virtual camera 250, based on the movement trajectory.

According to an embodiment, when capturing the video of the specific object while moving the virtual camera 250 based on the movement trajectory, in operation 307, the instructions stored in the memory 120, when executed individually or collectively by the at least one processor 110, may cause the electronic device 100 to zoom in or zoom out on and capture the specific object according to the movement points.

For example, if the specific object includes a face, the instructions stored in the memory 120, when executed individually or collectively by the at least one processor 110, may cause the electronic device 100 to enable the virtual camera 250 to zoom in on and capture the specific object at the start point. If the specific object includes a face, the instructions stored in the memory 120, when executed individually or collectively by the at least one processor 110, may cause the electronic device 100 to enable the virtual camera 250 to zoom out and capture the specific object at the passing point. If the specific object includes a face, the instructions stored in the memory 120, when executed individually or collectively by the at least one processor 110, may cause the electronic device 100 to enable the virtual camera 250 to zoom in on and capture the specific object at the end point.

For example, if the specific object does not include a face or the specific object is an inanimate object, the instructions stored in the memory 120, when executed individually or collectively by the at least one processor 110, may cause the electronic device 100 to enable the virtual camera 250 to zoom in on and capture the specific object at the start point. If the specific object includes a face, the instructions stored in the memory 120, when executed individually or collectively by the at least one processor 110, may cause the electronic device 100 to enable the virtual camera 250 to zoom out and capture the specific object at the end point.

According to an embodiment, in operation 309, the instructions stored in the memory 120, when executed individually or collectively by the at least one processor 110, may cause the electronic device 100 to display the 3D video on the display 140 or store the 3D video in the memory 130.

FIG. 4 is a diagram illustrating a method for recognizing a specific object 410 in an image 400 by the electronic device 100 according to an embodiment of the disclosure.

In an embodiment, a screen 401 is a diagram illustrating a method for recognizing the specific object 410 in the image 400 by using the segment engine 210. Referring to the screen 401, the segment engine 210 may perform segmentation on the image 400. The electronic device 100 may recognize and classify the specific object 410 (e.g., a cat) in the image 400 by using the segment engine 210. The electronic device 100 may identify a boundary of the specific object 410 included in the image 400 by using the segment engine 210, and recognize the specific object 410.

In an embodiment, the specific object 410 may include a region of interest. The specific object 410 or the region of interest may include a region or an object that a user desires to capture as a 3D video.

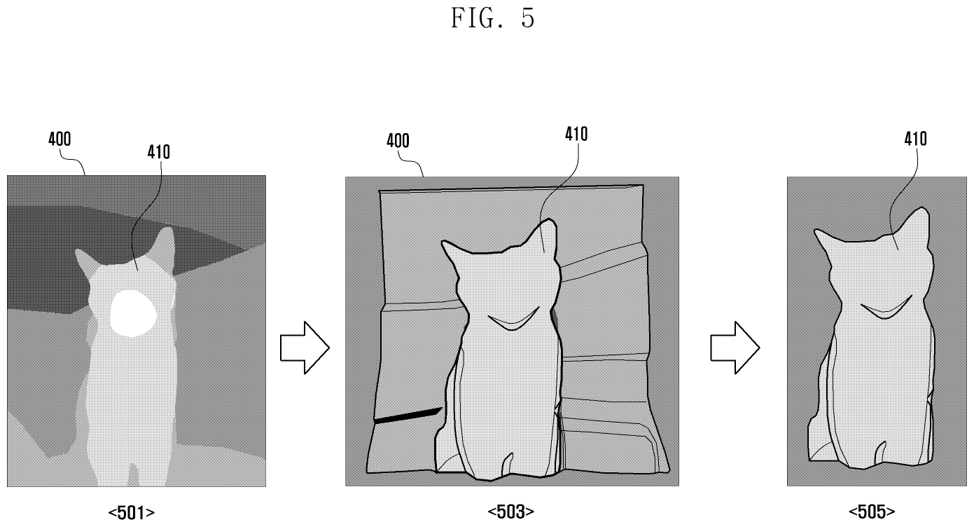

FIG. 5 is a diagram illustrating a method for recognizing the specific object 410 in the image 400 by the electronic device 100 according to an embodiment of the disclosure.

In an embodiment, screens 501, 503, and 505 illustrate a method for recognizing the specific object 410 in the image 400 by using the depth heat map 220.

On the screen 501, the depth heat map 220 may represent a depth of the object 410 (e.g., a cat) by using a color of each pixel in the image 400.

On the screen 503, the depth heat map 220 may infer and detect a distant view of a 2D image and convert the object included in the 2D image into a 3D mesh, based on depth information.

On the screen 505, the depth heat map 220 may separate foreground and background layers in the image 400 with reference to a part having the largest change in the Z-coordinate in the transformed 3D space, and identify the layer separated as the foreground as the specific object 410.

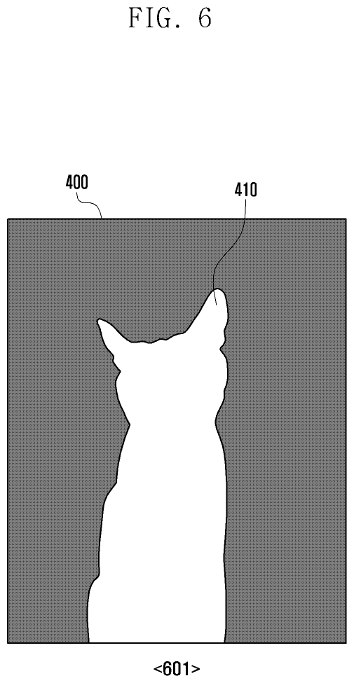

FIG. 6 is a diagram illustrating a method for recognizing the specific object 410 in the image 400 by the electronic device 100 according to an embodiment of the disclosure.

In an embodiment, a screen 601 is a diagram illustrating a method for recognizing the specific object 410 in the image 400 by using the saliency learning model 230.

On the screen 601, the saliency learning model 230 may evaluate the likelihood of each pixel being noticed in the image 400. The saliency learning model 230 may identify a region corresponding to a specific score or higher as the specific object 410 (e.g., a cat), based on the evaluation of the likelihood of being noticed.

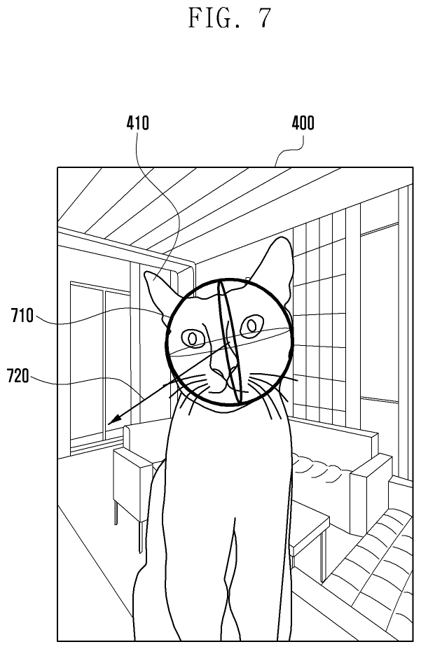

FIG. 7 is a diagram illustrating a method for recognizing a face of the specific object 410 in the image 400 and detecting the gaze by the electronic device 100 according to an embodiment of the disclosure.

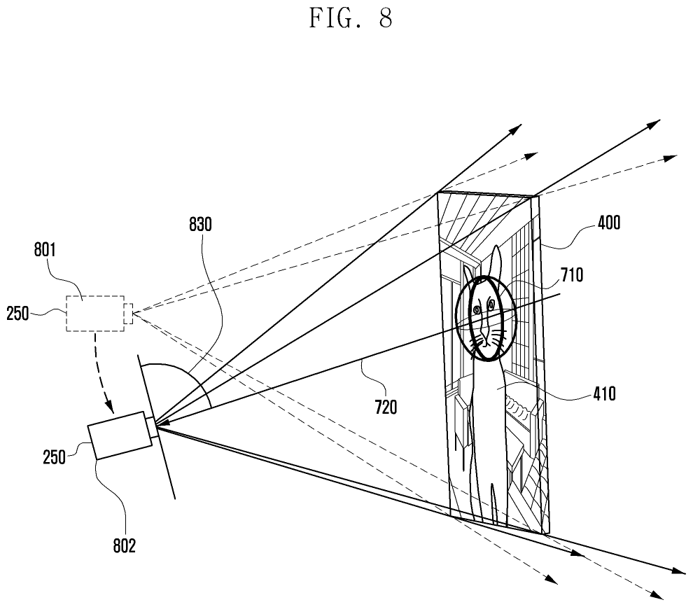

FIG. 8 is a diagram illustrating a method for recognizing a face of the specific object 410 in the image 400 and detecting the gaze by the electronic device 100 according to an embodiment of the disclosure.

Referring to FIG. 7, the electronic device 100 may identify three types of position information 710 regarding pitch, yaw, and roll of a face of the specific object 410 by using the face detection model 240. The electronic device 100 may identify gaze information 720 or gaze 720, based on the three types of position information 710 regarding the face of the specific object 410.

Referring to FIG. 8, the electronic device 100 may move the X and Y axes of the virtual camera 250 from a default position 801 to a point where the Z-axis of the gaze of the face in a 3D space meets the Z-axis where the virtual camera 250 is located, based on the three types of position information 710, thereby moving the virtual camera 250 to a position 802 of the virtual camera 250 where the gaze is directed in the 3D space. The electronic device 100 may configure an angle 830 (about 90 degrees) of the virtual camera 250 to make a 90-degree angle with the X and Y axes of the gaze, to thus cause the virtual camera 250 to face straight toward eyes of the specific object 410. The electronic device 100 may move the virtual camera 250 in a direction in which the specific object faces, to cause the virtual camera 250 to face straight toward the specific object 410, to detect the gaze of the specific object 410, based on a position and a direction of the virtual camera 250 facing (eye contacting) the specific object 410.

In an embodiment, the electronic device 100 may detect the gaze of the specific object 410 to identify a start point (e.g., 802) of a movement trajectory of the virtual camera 250 when generating a video of the specific object 410 by using the virtual camera 250. For example, since the virtual camera 250 may move in a direction of making an eye contact with a person or animal included in an image and zoom in, a natural representation of the movement of a person or animal in a 3D video generated by the electronic device 100 may be possible. In addition, since the virtual camera 250 may move in the direction of making an eye contact with the person or animal included in the image and zoom in, the direction in which the person or animal faces in the 3D video generated by the electronic device 100 may also include information on a region of interest and/or the specific object 410 included in the image. Therefore, when the movement trajectory of the virtual camera 250 is generated by focusing on the gaze of the specific object 410 included in the image, a high level of user satisfaction with the 3D video generated by the electronic device 100 may be provided.

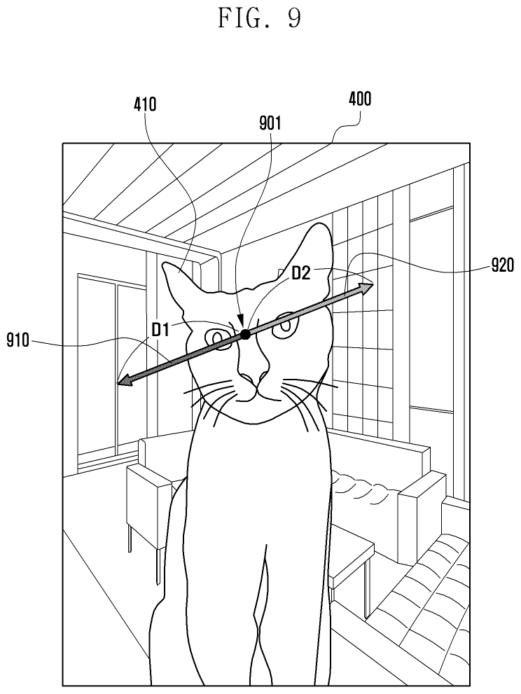

FIG. 9 is a diagram illustrating a method for identifying a start point 910 and an end point 920 by the electronic device 100 according to an embodiment of the disclosure.

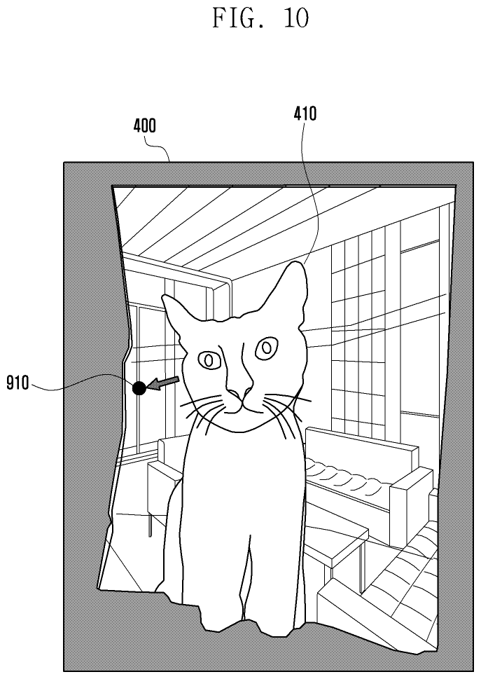

FIG. 10 is a diagram illustrating a method for identifying the start point 910 by the electronic device 100 according to an embodiment of the disclosure.

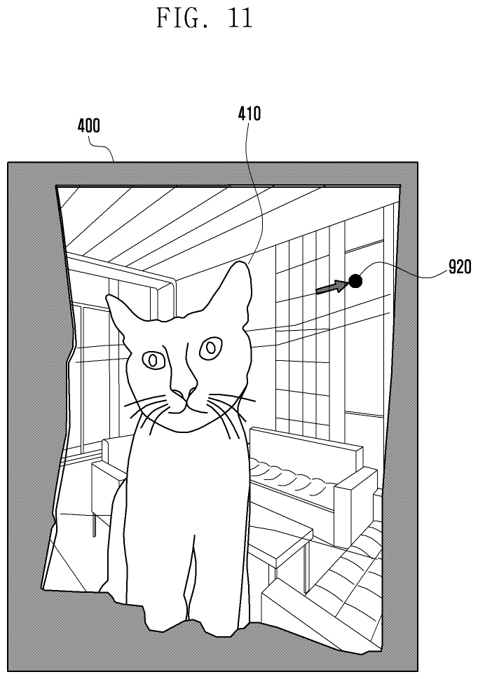

FIG. 11 is a diagram illustrating a method for identifying the end point 920 by the electronic device 100 according to an embodiment of the disclosure.

FIG. 9 is a diagram illustrating the start point 910 and the end point 920 on a 2D image, and FIGS. 10 and 11 are diagrams illustrating the start point 910 and the end point 920 of FIG. 9 in a 3D modeling environment.

Referring to FIGS. 9, 10, and 11, the start point 910 may include a position where capturing of a video of the specific object 410 included in the image 400 is started by using the virtual camera 250. An end point 920 may include a position where capturing of a video of the specific object 410 included in the image 400 is ended by using the virtual camera 250.

FIGS. 9, 10, and 11 are diagrams for consecutively explaining a method for identifying the start point 910 and the end point 920 with reference to the specific object 410 included in the image 400 by the electronic device 100 according to an embodiment of the disclosure.

Referring to FIGS. 9, 10, and 11, the start point 910 may include a gaze direction of the specific object 410. The start point 910 may include a position that is spaced apart from the object 410 by a specific distance D1 or more. The end point 920 may include a position that is rotated 180 degrees from the start point 910. The end point 920 may include a direction that is opposite to the direction of the gaze of the specific object 410. The end point 920 may include a direction that is rotated 180 degrees relative to the direction of the gaze of the specific object 410. The end point 920 may include a position that is spaced apart from the specific object by a specific distance D2 or more. The end point 920 may include an opposite direction of the start point 910 with reference to a center point 901 of a face.

In an embodiment, the start point 910 and the end point 920 may be spaced apart from the center point 901 by the specific distances D1 and D2, respectively. In an embodiment, the start point 910 may include the gaze direction. The start point may include a position that is spaced apart from the specific object 410 (or the center point 901 of the specific object 410) by the specific distance D1 or more.

In an embodiment, the end point 920 may include a position that is rotated 180 degrees from the start point 910. The end point 920 may include a direction that is opposite to the direction of the gaze. The end point 920 may include a direction that is rotated 180 degrees relative to the direction of the gaze. The end point 920 may include a position that is spaced apart from the specific object 410 (or the center point 901 of the specific object 410) by the specific distance D2 or more. The end point 920 may include an opposite direction of the start point 910 with reference to the center point 901 of the face.

FIGS. 9, 10, and 11 illustrate a method for identifying the start point 910 and the end point 920 by the electronic device 100 based on a case in which the specific object 410 included in the image 400 includes a face and a perspective. However, when the specific object 410 included in the image 400 includes a face but perspective analysis is impossible or difficult, for example, when a face image included in the specific object 410 is small or in a side view, the instructions stored in the memory 120, when executed individually or collectively by the at least one processor 110, may cause the electronic device 100 to identify the start point 910 and the end point 920 with respect to the face regardless of the gaze.

For example, when the specific object 410 included in the image 400 includes a face but perspective analysis is impossible or difficult, the instructions stored in the memory 120, when executed individually or collectively by the at least one processor 110, may cause the electronic device 100 to configure a center of the face as the center point 901, identify a specific point in the left direction from the center point 901 as the start point 910, and identify a specific point in the right direction from the center point 901 as the end point 920.

However, the disclosure is not limited thereto, and when the specific object 410 included in the image 400 includes a face but perspective analysis is impossible or difficult, the instructions stored in the memory 120, when executed individually or collectively by the at least one processor 110, may cause the electronic device 100 to configure the center of the face as the center point 901, identify a specific point in the right direction from the center point 901 as the start point 910, and identify a specific point in the left direction from the center point 901 as the end point 920.

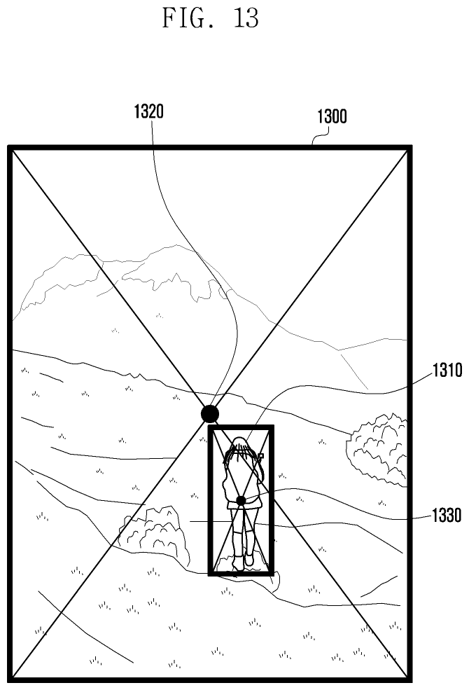

In addition, a case where the specific object 410 included in the image 400 does not include a face may be explained with reference to FIG. 13 described below.

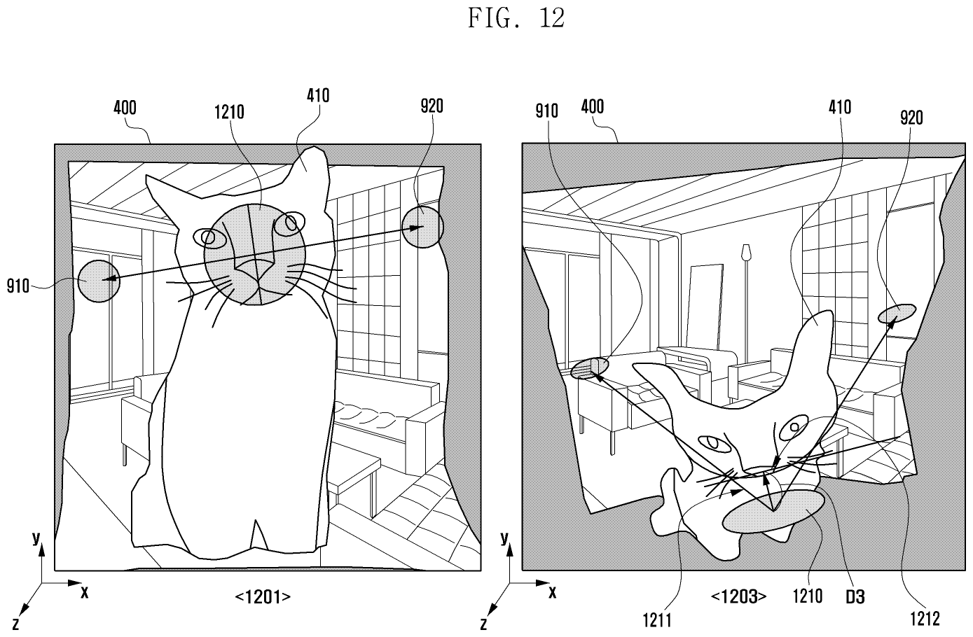

FIG. 12 is a diagram illustrating a method for identifying a passing point 1210 by the electronic device 100 based on the start point 910 and the end point 920 according to an embodiment of the disclosure.

A screen 1201 is a diagram illustrating a passing point 1210 on a 2D image, and a screen 1203 is a diagram illustrating a passing point 1210 in a 3D modeling environment.

Referring to the screen 1201, the passing point 1210 may include an intermediate position between the start point 910 and the end point 920 on the X and Y coordinates of a 2D coordinate system.

Referring to the screen 1203, to prevent the virtual camera 250 from capturing the specific object 410 by passing through the specific object 410 included in the image 400 in the 3D modeling environment, the electronic device 100 may, under the control of the at least one processor 110, identify the passing point 1210 at a position spaced apart by a specific distance D3 from the Z-coordinate of the specific object 410.

Referring to the screen 1203, to prevent the virtual camera 250 from capturing the specific object 410 by passing through the specific object 410 included in the image 400 in the 3D modeling environment, the electronic device 100 may, under the control of the at least one processor 110, identify, as the passing point 1210, a point where a path 1211 connecting the start point 910 and the end point 920 does not pass through the specific object 410.

In an embodiment, in the 3D modeling environment, the specific object 410 may be located at a position 1212 having the largest Z coordinate value, and the electronic device 100 may, under the control of the at least one processor 110, identify a position that is spaced apart by the specific distance D3 from the position 1212 having the largest Z coordinate value of the specific object 410 as the passing point 1210. When capturing a 3D video, the virtual camera 250 may move from the passing point 1210 while facing the specific object 410.

In an embodiment, a movement point and a movement trajectory may be a trajectory or a flight path along which the virtual camera 250 moves within an image, and the electronic device 100 may generate a virtual path to provide, to a user, an effect in which the virtual camera 250 appears to move while facing the specific object, and identify a start point, an end point, and/or a passing point of the virtual path, and a movement trajectory, and provide, to the user, a scene in which the virtual camera 250 appears to capture an image while moving along the movement point and the movement trajectory identified by the camera.

In an embodiment, a specific object in a 3D space may be at a point having the largest Z-axis coordinate value, and the virtual camera 250 may move while facing the object by using a corresponding position as a passing point.

FIG. 13 is a diagram illustrating a method for identifying a start point 1330 and an end point 1320 by the electronic device 100 when a specific object 1310 does not include a face according to an embodiment of the disclosure.

FIG. 12 illustrates that the specific object 410 (e.g., a cat) includes a face, but a specific object 1310 (e.g., a person) of FIG. 13 does not include a face.

Referring to FIG. 13, even if the specific object 1310 includes an animal or a person but does not include a face, the instructions stored in the memory 120, when executed individually or collectively by the at least one processor 110, may cause the electronic device 100 to identify a center of the specific object 1310 as a start point 1330, and identify the center of an image as an end point 1320. A passing point (not shown) may include an intermediate position between the start point 1330 and the end point 1320.

In an embodiment, even if the specific object 1310 includes an animal or a person but does not include a face, the instructions stored in the memory 120, when executed individually or collectively by the at least one processor 110, may cause the electronic device 100 to identify the center of the specific object 1310 as the start point 1330, and identify the center of the image as the end point 1320 without separately identifying a center point or the passing point.

In an embodiment, if the specific object 1310 includes an animal or a person but does not include a face, the instructions stored in the memory 120, when executed individually or collectively by the at least one processor 110, may cause the electronic device 100 to, when generating a 3D video by using the virtual camera 250, enable the virtual camera 250 to zoom in on and capture the specific object 1310 at the start point 1330, and gradually zoom out and capture the specific object 1310 as the virtual camera 250 moves towards the end point 1320.

However, the disclosure is not limited thereto, and if the specific object 1310 includes an animal or a person but does not include a face, the instructions stored in the memory 120, when executed individually or collectively by the at least one processor 110, may cause the electronic device 100 to, when generating a 3D video by using the virtual camera 250, enable the virtual camera 250 to zoom out and capture the specific object 1310 at the start point 1330 and gradually zoom in on and capture the specific object 1310 as the virtual camera 250 moves toward the end point 1320.

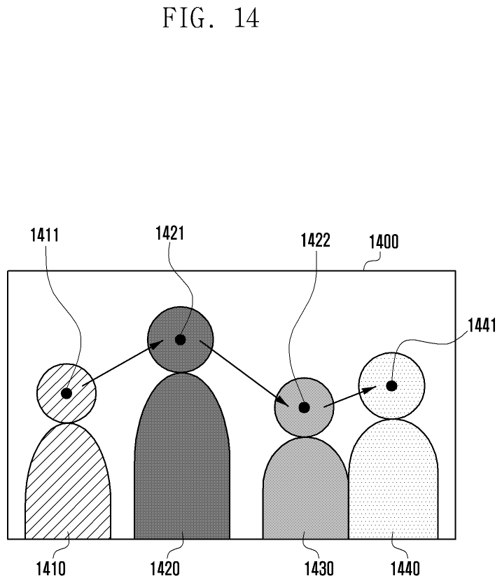

FIG. 14 is a diagram illustrating a case where multiple specific objects 1410, 1420, 1430, and 1440 are included in an image 1400 according to an embodiment of the disclosure.

FIG. 14 illustrates that each of multiple specific objects 1410, 1420, 1430, and 1440 included in the image 1400 may include a face according to an embodiment of the disclosure.

Referring to FIG. 14, if multiple specific objects 1410, 1420, 1430, and 1440 are included in the image 1400, the instructions stored in the memory 120, when executed individually or collectively by the at least one processor 110, may cause the electronic device 100 to identify the specific object 1410 on a far left as a start point, and identify the specific object 1440 on a far right as an end point. In this case, passing points may include specific objects 1420 and 1430 located between the start point and the end point. However, the disclosure is not limited thereto, and if the multiple specific objects are included in the image, the instructions stored in the memory 120, when executed individually or collectively by the at least one processor 110, may cause the electronic device 100 to identify the specific object 1440 on the far right as the start point, and identify the specific object 1410 on the far left as the end point.

In an embodiment, if the multiple specific objects 1410, 1420, 1430, and 1440 are included in the image 1400, the instructions stored in the memory 120, when executed individually or collectively by the at least one processor 110, may cause the electronic device 100 to identify a center point 1411 of the specific object 1410 on the far left as the start point, and identify a center point 1441 of the specific object 1440 on the far right as the end point. In this case, passing points may include center points 1421 and 1431 of the specific objects 1420 and 1430 located between the start point and the end point. However, the disclosure is not limited thereto, and if the multiple specific objects are included in the image, the instructions stored in the memory 120, when executed individually or collectively by the at least one processor 110, may cause the electronic device 100 to identify the specific object 1440 on the far right as the start point, and identify the specific object 1410 on the far left as the end point.

In an embodiment, when multiple passing points (e.g., 1420 and 1430) are generated, a length of a path along which the virtual camera 250 for 3D video generation moves may increase. When the length of the path along which the virtual camera 250 for 3D video generation moves increases, a playback time of the entire 3D video may also increase. When multiple passing points (e.g., 1420 and 1430) are generated, in order to shorten the playback time of the 3D video, the instructions stored in the memory 120, when executed individually or collectively by the at least one processor 110, may cause the electronic device 100 to compensate for a movement time of the virtual camera 250 for capturing a 3D video to correspond to a time for capturing a 3D video of a single specific object.

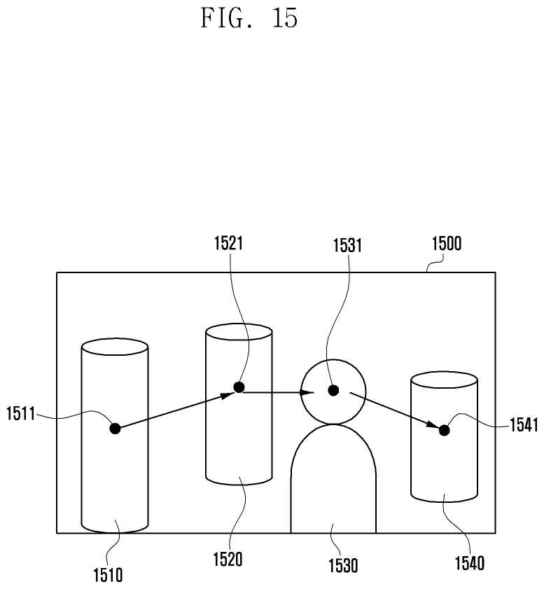

FIG. 15 is a diagram illustrating a case where multiple specific objects 1510, 1520, 1530, and 1540 are included in an image 1500 according to an embodiment of the disclosure.

Each of the multiple specific objects 1410, 1420, 1430, and 1440 included in the image 1400 of FIG. 14 includes a face, but at least some of multiple specific objects 1510, 1520, 1530, and 1540 may include an object that does not include a face. For example, in an image 1500, only the specific object 1530 includes a face, and the remaining specific objects 1510, 1520, and 1540 may be inanimate objects or may not include faces.

Referring to FIG. 15, if the multiple specific objects 1510, 1520, 1530, and 1540 are included in the image 1500, the instructions stored in the memory 120, when executed individually or collectively by the at least one processor 110, may cause the electronic device 100 to identify the specific object 1510 on the far left as a start point, and identify the specific object 1540 on the far right as an end point. In this case, passing points may include the specific objects 1520 and 1530 located between the start point and the end point. However, the disclosure is not limited thereto, and if the multiple specific objects are included in the image, the instructions stored in the memory 120, when executed individually or collectively by the at least one processor 110, may cause the electronic device 100 to identify the specific object 1540 on the far right as the start point, and identify the specific object 1510 on the far left as the end point.

In an embodiment, if the multiple specific objects 1510, 1520, 1530, and 1540 are included in the image 1400, the instructions stored in the memory 120, when executed individually or collectively by the at least one processor 110, may cause the electronic device 100 to identify a center point 1511 of the specific object 1510 on the far left as the start point, and identify a center point 1541 of the specific object 1540 on the far right as the end point. In this case, passing points may include center points 1521 and 1531 of the specific objects 1520 and 1530 located between the start point and the end point. However, the disclosure is not limited thereto, and if the multiple specific objects are included in the image, the instructions stored in the memory 120, when executed individually or collectively by the at least one processor 110, may cause the electronic device 100 to identify the specific object 1540 on the far right as the start point, and identify the specific object 1510 on the far left as the end point.

In an embodiment, when multiple passing points (e.g., 1520 and 1530) are generated, a length of a path along which the virtual camera 250 for 3D video generation moves may increase. When the length of the path along which the virtual camera 250 for 3D video generation moves increases, a playback time of the entire 3D video may also increase. When multiple passing points (e.g., 1520 and 1530) are generated, in order to shorten the playback time of the 3D video, the instructions stored in the memory 120, when executed individually or collectively by the at least one processor 110, may cause the electronic device 100 to compensate for a movement time of the virtual camera 250 for capturing a 3D video to correspond to a time for capturing a 3D video of a single specific object.

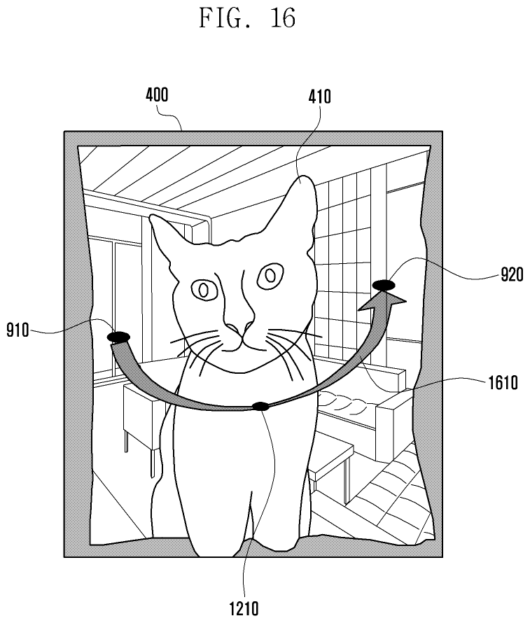

FIG. 16 is a diagram illustrating a method for identifying a movement trajectory 1610 by the electronic device 100 according to an embodiment of the disclosure.

According to an embodiment, the instructions stored in the memory 120, when executed individually or collectively by the at least one processor 110, may cause the electronic device 100 to identify a movement trajectory 1610 based on at least one movement point 910, 920, and 1210. The movement trajectory 1610 may include a trajectory along which the virtual camera 250 moves while capturing the specific object 410 in a 3D modeling environment. The movement trajectory 1610 may include a direction in which the virtual camera 250 captures the specific object in the 3D modeling environment. The direction in which the virtual camera 250 captures the specific object in the 3D modeling environment may always be directed toward the specific object.

In an embodiment, the movement trajectory 1610 may include a trajectory along which at least one movement point 910, 920, and 1210 moves along a curve. The movement trajectory 1610 may include the start point 910, the end point 920, and the passing point 1210. The movement trajectory 1610 may include a Bezier curve or a cardinal spline.

In an embodiment, the movement trajectory 1610 may include a Bezier curve or a cardinal spline such that when a number of complex passing points are generated, the movement trajectory of the virtual camera 250 also draws a complex movement path, but when a Bezier curve or a cardinal spline is used, the virtual camera may move along all movement points, and move in a curve between the movement points, and thus may achieve a natural movement.

In an embodiment, the instructions stored in the memory 120, when executed individually or collectively by the at least one processor 110, may cause the electronic device 100 to move the virtual camera 250 with respect to the specific object 410 while drawing a curve (e.g., the movement trajectory 1610) along the X, Y, and Z coordinates when capturing a 3D video.

In an embodiment, the movement trajectory 1610 may include a trajectory along which a movement point moves along a straight line. The movement trajectory 1610 may include the start point 910 and the end point 920. For example, even if the specific object includes an animal or a person, if the specific object does not include a face, the instructions stored in the memory 120, when executed individually or collectively by the at least one processor 110, may cause the electronic device 100 to identify the center of the object as the start point, and identify the center of an image as the end point. In this case, a passing point is not identified, and a movement trajectory may be generated as a straight line.

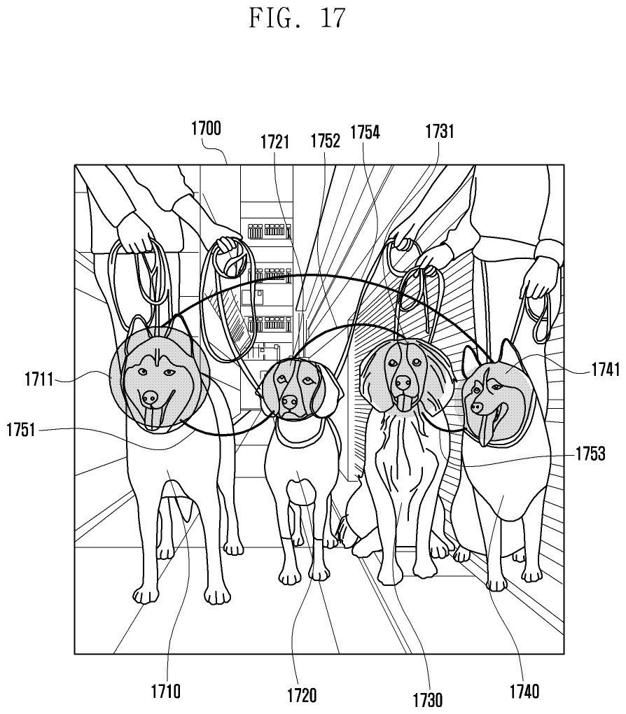

FIG. 17 is a diagram illustrating a method for identifying movement trajectories 1751, 1752, 1753, and 1754 by the electronic device 100 when multiple specific objects 1710, 1720, 1730, and 1740 are included in an image 1700 according to an embodiment of the disclosure.

In an embodiment, if multiple specific objects 1710, 1720, 1730, and 1740 are included in an image 1700, the instructions stored in the memory 120, when executed individually or collectively by the at least one processor 110, may cause the electronic device 100 to identify the specific object 1710 on the far left as a start point 1711, and identify the specific object 1740 on the far right as an end point 1741. In this case, passing points 1721 and 1731 may be included in the specific objects 1720 and 1730 located between the start point 1711 and the end point 1711.

In an embodiment, movement trajectories 1751, 1752, 1753, and 1754 may include a trajectory along which at least one movement point 1711, 1721, 1731, and 1741 moves along a curve. The movement trajectories 1751, 1752, 1753, and 1754 may include the start point 1711, the end point 1741, and the passing points 1721 and 1731. The movement trajectories 1751, 1752, 1753, and 1754 may include curves or straight lines.

In an embodiment, in order to generate a movement trajectory (e.g., a curve), the number of movement points may be limited to a specific number or more. For example, only when there are at least three movement points, the instructions stored in the memory 120, when executed individually or collectively by the at least one processor 110, may cause the electronic device 100 to generate a movement trajectory including a curve by using the movement points.

In an embodiment, since a specific object is singular and an image without face information includes only two movement points, a movement path may be a straight line. In this case, the specific object may be captured using zoom-in and zoom-out techniques.

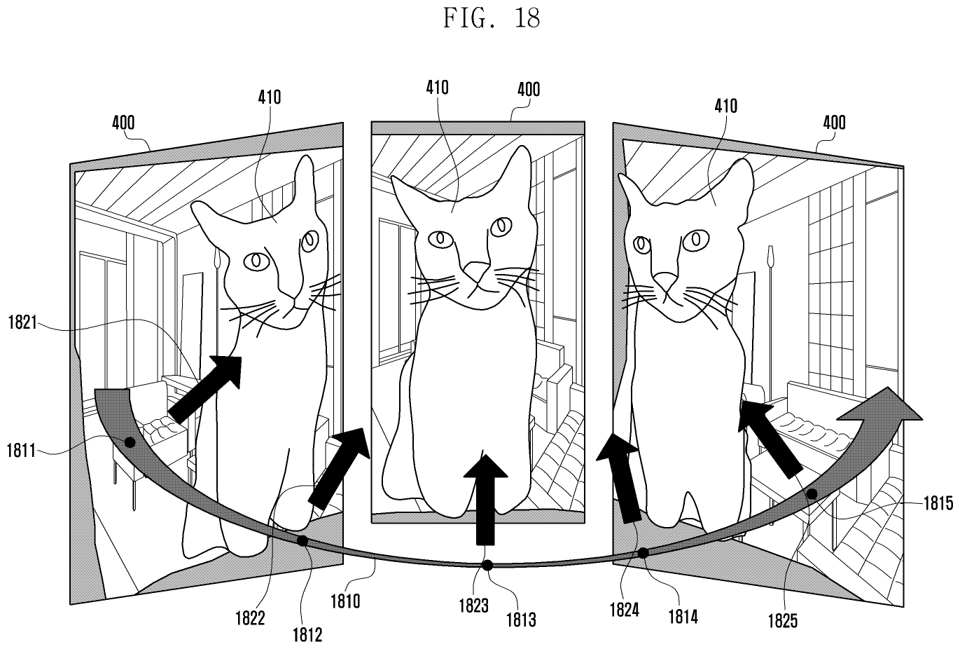

FIG. 18 is a diagram illustrating perspectives 1821, 1822, 1823, 1824, and 1825 of the virtual camera 250 when the electronic device 100 captures the specific object 410 of the image 400 along a movement trajectory 1810 according to an embodiment of the disclosure.

In an embodiment, the movement trajectory 1810 may include the perspectives 1821, 1822, 1823, 1824, and 1825 at which the virtual camera 250 captures the specific object 410 in a 3D modeling environment. The perspectives 1821, 1822, 1823, 1824, and 1825 at which the virtual camera 250 captures the specific object 410 in the 3D modeling environment may always be directed toward the specific object 410.

In an embodiment, the movement trajectory 1810 may include directions 1821, 1822, 1823, 1824, and 1825 in which the virtual camera 250 captures the specific object 410 in the 3D modeling environment. The directions 1821, 1822, 1823, 1824, and 1825 in which the virtual camera 250 captures the specific object 410 in the 3D modeling environment may be fixed to always face the specific object 410.

In an embodiment, after the movement trajectory 1810 is generated, the instructions stored in the memory 120, when executed individually or collectively by the at least one processor 110, may cause the electronic device 100 to control a perspective or perspective direction as viewed by the virtual camera 250. If the virtual camera 250 moves in one direction in a fixed state without the perspective or perspective direction facing the object, the virtual camera 250 may capture an outer part of an image as a 3D video. Therefore, the perspective or perspective direction of the virtual camera 250 may be adjusted to be centered around the specific object 410.

For example, the movement trajectory 1810 may include a start point 1811, a first passing point 1812, a second passing point 1813, a third passing point 1814, and an end point 1815. When moving from the start point 1811 to the first passing point 1812, the perspective direction of the virtual camera 250 is directed toward the first passing point 1812, and when moving past the first passing point 1812 and to the second point 1813, the perspective of the virtual camera 250 may also change its direction to target the second point 1813.

In an embodiment, when multiple specific objects are included in the image, the instructions stored in the memory 120, when executed individually or collectively by the at least one processor 110, may cause the electronic device 100 to configure the perspective direction of the virtual camera 250 such that the perspective direction of the virtual camera 250 faces a next movement point (e.g., a passing point) when moving between the specific objects.

In an embodiment, even if the multiple specific objects are included in the image, a start point and an end point may exist in the image, just as in the case where the image includes one specific object. Therefore, the perspective of the virtual camera 250 may be controlled to face each specific object. If the virtual camera 250 moves in one direction in a fixed state without the perspective or perspective direction facing the object, the virtual camera 250 may capture the outer part of the image as a 3D video. Therefore, the perspective or perspective direction of the virtual camera 250 may be adjusted to be centered on respective specific objects corresponding to the movement points.

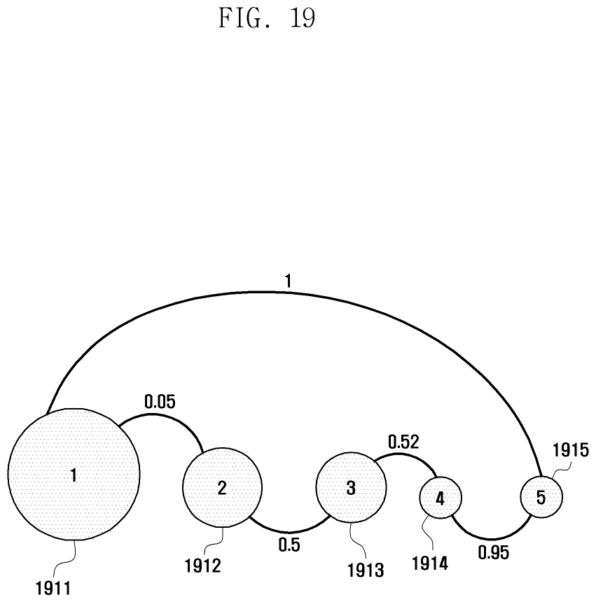

FIG. 19 is a diagram schematically illustrating a movement time of the virtual camera 250 between movement points according to an embodiment of the disclosure.

In an embodiment, the instructions stored in the memory 120, when executed individually or collectively by the at least one processor 110, may cause the electronic device 100 to make a movement time between movement points 1911, 1912, 1913, 1914, and 1915 of the virtual camera 250 the same or linear.

In an embodiment, the instructions stored in the memory 120, when executed individually or collectively by the at least one processor 110, may cause the electronic device 100 to differentially allocate the movement time between the movement points 1911, 1912, 1913, 1914, and 1915 of the virtual camera 250.

In an embodiment, after a movement trajectory and a perspective of the virtual camera 250 are generated, by controlling a time interval between the movement points of the virtual camera 250, the instructions stored in the memory 120, when executed individually or collectively by the at least one processor 110, may cause the electronic device 100 to, when generating a 3D video, provide a slow or fast effect to the generated video.

For example, the instructions stored in the memory 120, when executed individually or collectively by the at least one processor 110, may cause the electronic device 100 to distribute a movement time of the virtual camera 250 between a start point 1911 and a first passing point 1912 as 0.05 (unit, e.g., seconds), a movement time between the first passing point 1912 and a second passing point 1913 as 0.5 (unit, e.g., seconds), a movement time of the virtual camera 250 between the second passing point 1913 and a third passing point 1914 as 0.52 (unit, e.g., seconds), a movement time of the virtual camera 250 between the third passing point 1914 and an end point 1915 as 0.92 (unit, e.g., seconds), and a movement time of the virtual camera 250 between the end point 1915 and the start point 1911 as 1 (unit, e.g., seconds). In this case, when the electronic device 100 captures a 3D video for a specific object, the 3D video may include a fast or slow effect due to the time difference in moving to each movement point. When the electronic device 100 captures a 3D video for a specific object, the 3D video may include a Glambot capturing effect due to the time difference in moving to each movement point.

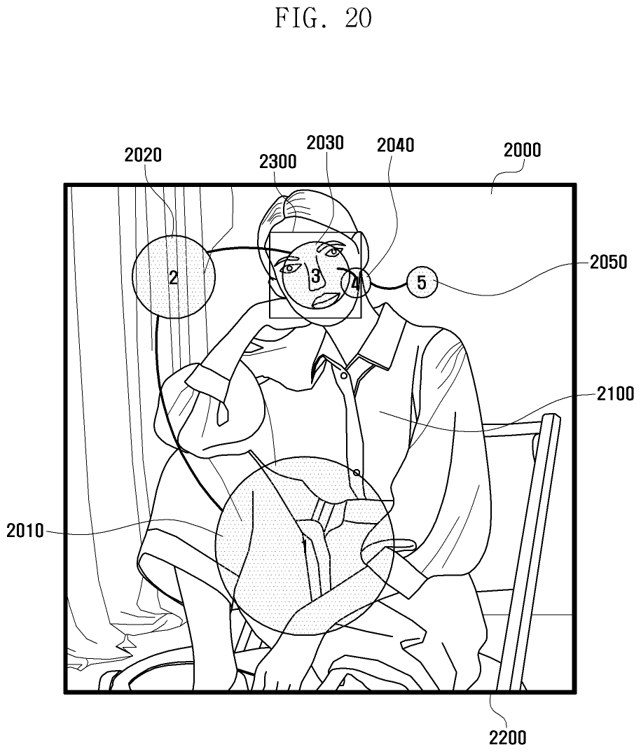

FIG. 20 is a diagram illustrating a method for capturing a 3D video by the electronic device 100 with a Glambot capturing effect for a specific object 2100 included in an image 2000, according to an embodiment of the disclosure.

In an embodiment, the instructions stored in the memory 120, when executed individually or collectively by the at least one processor 110, may cause the electronic device 100 to capture a 3D video by causing the virtual camera 250 to first capture an entire screen 2200, and then capture the specific object 2100 while moving in an order of a start point 2010, a first passing point 2020, a second passing point 2030, a third passing point 2040, and an end point 2050. In this case, a zoom size for the specific object 2100 may be determined in an order of the entire screen 2200, the start point 2010, the first passing point 2020, the second passing point 2030, the third passing point 2040, and the end point 2050, and the virtual camera 250 may capture the specific object 2100 by gradually narrowing the zoom size in an order of the entire screen 2200, the start point 2010, the first passing point 2020, the second passing point 2030, the third passing point 2040, and the end point 2050.

For example, in relation to the Glambot capturing effect, the virtual camera 250 may rapidly zoom in on the specific object 2100 from a remote point (e.g., the entire screen 2200) with respect to a face 2300 of the specific object 2100, and approach along a curved path, and then a movement time between movement points (e.g., the first passing point 2020 and the second passing point 2030) near the face of the specific object 2100 may be lengthened, and thus the virtual camera 250 may move in slow motion to capture the specific object, and then move to the end point 2050 to highlight the specific object 2100 (e.g., face) after zooming in again between movement points (e.g., the second passing point 2030 and the third passing point 2040).

In an embodiment, in order to implement the Glambot capturing effect, the instructions stored in the memory 120, when executed individually or collectively by the at least one processor 110, may cause the electronic device 100 to distinguish and recognize portions of the object 2100 included in the image 2000 as a first specific object (e.g., a face), a second specific object (e.g., an upper body), and a third specific object (e.g., a full body).

In an embodiment, the instructions stored in the memory 120, when executed individually or collectively by the at least one processor 110, may cause the electronic device 100 to capture a 3D video in slow motion by slowing down a movement time of the virtual camera 250 between movement points while moving in order from a specific object with lower importance (e.g., the third specific object) to a specific object with higher importance (e.g., the first specific object).

In an embodiment, the instructions stored in the memory 120, when executed individually or collectively by the at least one processor 110, cause the electronic device 100 to move the virtual camera 250 from a movement point (e.g., the entire screen 2200) corresponding to the third specific object (e.g., a full body) to a movement point (e.g., the start point 2010, the first passing point 2020) corresponding to the second specific object (e.g., an upper body), and then move the virtual camera 250 from the movement point (e.g., the start point 2010, the first passing point 2020) corresponding to the second specific object (e.g., an upper body) to a movement point (e.g., the second passing point 2030) corresponding to the first specific object (e.g., a face), thereby capturing a 3D video.

In an embodiment, the instructions stored in the memory 120, when executed individually or collectively by the at least one processor 110, may cause the electronic device 100 to capture a 3D video including a slow motion effect by lengthening the movement time of the virtual camera 250 when moving to the most important object (e.g., the first specific object).

In an embodiment, the instructions stored in the memory 120, when executed individually or collectively by the at least one processor 110, may cause the electronic device 100 to designate an important object and capture a 3D video including a slow motion effect at the most important object. The electronic device 100 of the disclosure may capture a 3D video having various capturing effects applied thereto, such as the Glambot capturing effect, zoom-in, fast motion, and tilt roll, corresponding to various objects according to a method for selecting priorities of important objects in an image such as an animal, an inanimate object, and a landscape.

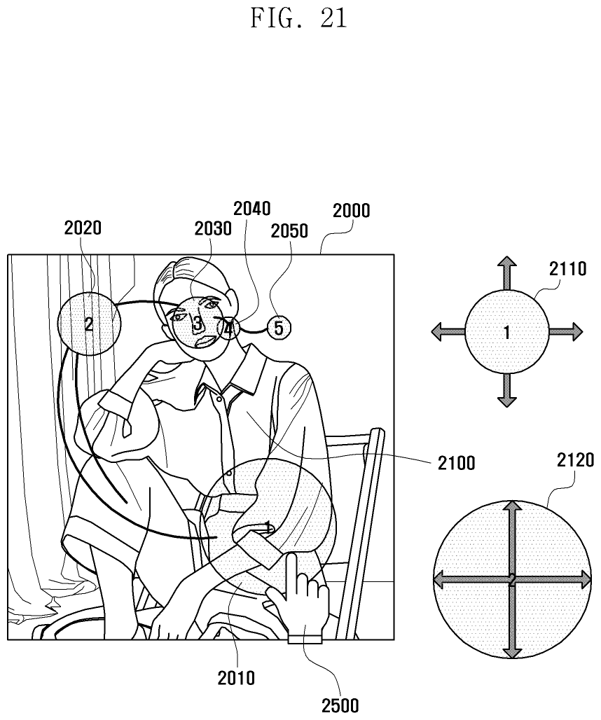

FIG. 21 is a diagram illustrating a user interface in which a position movement and a zoom effect of a movement point are changeable according to a user input according to an embodiment of the disclosure.

According to an embodiment, the instructions stored in the memory 120, when executed individually or collectively by the at least one processor 110, may cause the electronic device 100 to display, on the display 140, a user interface 2110 related to a position change in which a position of a movement point is changeable by a user input 2500.

According to an embodiment, the instructions stored in the memory 120, when executed individually or collectively by the at least one processor 110, may cause the electronic device 100 to display, on the display 140, the user interface 2110 related to a position change in which an order of a movement point is changeable by a user input.

In an embodiment, the user interface 2110 related to the position change may correspond to the start point 2010, the first passing point 2020, the second passing point 2030, the third passing point 2040, and the end point 2050 of FIGS. 20 and 21. The user interface 2110 related to the position change may include the start point 2010, the first passing point 2020, the second passing point 2030, the third passing point 2040, and the end point 2050 of FIGS. 20 and 21.

According to an embodiment, the instructions stored in the memory 120, when executed individually or collectively by the at least one processor 110, may cause the electronic device 100 to display, on the display 140, a user interface 2120 related to zoom of which zoom-in/zoom-out is changeable when capturing a specific object at a movement point by a user input. A user input for changing the size of the user interface 2120 related to zoom may include pinch zoom in/out or a press input.

A size (e.g., a size of a circle) of the user interface 2120 related to zoom may be changeable by the user input 2500. The electronic device 100 may capture a 3D video of the specific object 2100 by using the virtual camera 250 by zooming in on the specific object in proportion to the size of the user interface 2120 related to zoom. The user interface 2120 related to zoom may correspond to the start point 2010, the first passing point 2020, the second passing point 2030, the third passing point 2040, and the end point 2050 of FIGS. 20 and 21. The user interface 2120 related to zoom may include the start point 2010, the first passing point 2020, the second passing point 2030, the third passing point 2040, and the end point 2050 of FIGS. 20 and 21.

In an embodiment, the electronic device 100 may include the display 140, the at least one processor 110, and the memory 120 configured to store instructions, wherein the instructions, when executed individually or collectively by the processor 110, cause the electronic device 100 to identify a specific object in an image, identify at least one movement point of the virtual camera 250, based on a position of the specific object, identify a movement trajectory, based on the at least one movement point, capture a video, based on the movement trajectory, and display the video on the display 140 or store the video in the memory 120.

In an embodiment, the video includes a three-dimensional (3D) video, and the instructions, when executed by the processor 110, may cause the electronic device 100 to identify the specific object in the image by using at least one of the segment engine 210, the depth heat map 220, or the saliency learning model 230.

In an embodiment, the instructions, when executed individually or collectively by the processor 110, may cause the electronic device 100 to identify a face and a gaze in the specific object.

In an embodiment, the instructions, when executed individually or collectively by the processor 110, may cause the electronic device 100 to identify the at least one movement point including a start point, an end point, and a passing point, based on the identified face and gaze of the specific object.

In an embodiment, the instructions, when executed individually or collectively by the processor 110, may cause the electronic device 100 to identify an intermediate point between the start point and the end point as the passing point.

In an embodiment, the instructions, when executed individually or collectively by the processor 110, may cause the electronic device 100 to generate, in a 3D space for the image, the movement trajectory which passes through the start point, the end point, and the passing point while drawing a curved trajectory.

In an embodiment, the instructions, when executed individually or collectively by the processor 110, may cause the electronic device 100 to generate the curved trajectory, based on a Bezier curve or a cardinal spline.

In an embodiment, the instructions, when executed individually or collectively by the processor 110, may cause the electronic device 100 to fix a direction of the virtual camera 250 to a direction toward the specific object while moving the virtual camera 250 along the movement trajectory.

In an embodiment, the instructions, when executed individually or collectively by the processor 110, may cause the electronic device 100 to make a capturing time different according to the start point, the end point, and the passing point when capturing the specific object in the 3D space according to the movement trajectory.

In an embodiment, the instructions, when executed individually or collectively by the processor 110, may cause the electronic device 100 to, when there are multiple objects in the image, identify multiple passing points, based on the multiple objects.

In an embodiment, a 3D image display method of the electronic device 100 may include operations of: identifying a specific object in an image; identifying at least one movement point of the virtual camera 250, based on a position of the specific object; identifying a movement trajectory, based on the at least one movement point; capturing a video, based on the movement trajectory; and displaying the video on a display 140 and/or storing the video in a memory 120.

In an embodiment, the video includes a three-dimensional (3D) video, and in an embodiment, the 3D image display method of the electronic device 100 may further include an operation of identifying the specific object in the image by using at least one of the segment engine 210, the depth heat map 220, or the saliency learning model 230.

In an embodiment, the 3D image display method of the electronic device 100 may further include an operation of identifying a face and a gaze in the specific object.

In an embodiment, the 3D image display method of the electronic device 100 may further include an operation of identifying the at least one movement point including a start point, an end point, and a passing point, based on the identified face and gaze of the specific object.

In an embodiment, the 3D image display method of the electronic device 100 may further include identifying an intermediate point between the start point and the end point as the passing point.

In an embodiment, the 3D image display method of the electronic device 100 may further include an operation of generating, in a 3D space for the image, the movement trajectory which passes through the start point, the end point, and the passing point while drawing a curved trajectory.

In an embodiment, the 3D image display method of the electronic device 100 may further include an operation of generating the curved trajectory, based on a Bezier curve or a cardinal spline.

In an embodiment, the 3D image display method of the electronic device 100 may include an operation of fixing a direction of the virtual camera 250 to a direction toward the specific object while moving the virtual camera 250 along the movement trajectory.

In an embodiment, the 3D image display method of the electronic device 100 may further include an operation of making a capturing time different according to the start point, the end point, and the passing point when capturing the specific object in the 3D space according to the movement trajectory.

In an embodiment, the 3D image display method of the electronic device 100 may further include an operation of, when there are multiple objects in the image, identifying multiple passing points, based on the multiple objects.

In an electronic device and a three-dimensional image display method according to an embodiment of the disclosure, by displaying a three-dimensional (3D) image, generated based on a two-dimensional (2D) image, as an image and/or a video captured in a virtual space, the generated 3D image may be naturally provided to a user.

The electronic device according to various embodiments may be one of various types of electronic devices. The electronic device may include, for example, a portable communication device (e.g., a smart phone), a computer device, a portable multimedia device, a portable medical device, a camera, a wearable device, or a home appliance. The electronic device according to embodiments of the disclosure is not limited to those described above.

It should be appreciated that an embodiment and the terms used therein are not intended to limit the technological features set forth herein to particular embodiments and the disclosure includes various changes, equivalents, and/or alternatives for a corresponding embodiment. With regard to the description of the drawings, similar reference numerals may be used to designate similar or relevant elements. A singular form of a noun corresponding to an item may include one or more of the items, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one or all possible combinations of the items enumerated together in a corresponding one of the phrases. Such terms as “a first,” “a second,” “the first,” and “the second” may be used to simply distinguish a corresponding element from another, and does not limit the elements in other aspect (e.g., importance or order). If an element (e.g., a first element) is referred to, with or without the term “operatively” or “communicatively”, as “coupled with/to” or “connected with/to” another element (e.g., a second element), it means that the element may be coupled/connected with/to the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. The “module” may be a single integrated component, or a minimum unit or part thereof, adapted to perform one or more functions. For example, according to an embodiment, the “module” may be implemented in the form of an application-specific integrated circuit (ASIC).

An embodiment as set forth herein may be implemented as software (e.g., a program) including one or more instructions that are stored in a storage medium (e.g., an internal memory or external memory) that is readable by a machine (e.g., the electronic device 100). For example, a processor (e.g., the processor 110) of the machine (e.g., the electronic device 100) may invoke at least one of the one or more instructions stored in the storage medium, and execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Herein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, methods according to an embodiment of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment, each element (e.g., a module or a program) of the above-described elements may include a single entity or multiple entities, and some of the multiple entities may also be separately disposed in another element. According to an embodiment, one or more of the above-described elements may be omitted, or one or more other elements may be added. Alternatively or additionally, a plurality of elements (e.g., modules or programs) may be integrated into a single element. In such a case, according to various embodiments, the integrated element may still perform one or more functions of each of the plurality of elements in the same or similar manner as they are performed by a corresponding one of the plurality of elements before the integration. According to various embodiments, operations performed by the module, the program, or another element may be carried out sequentially, in parallel, repeatedly, or heuristically, or one or more of the operations may be executed in a different order or omitted, or one or more other operations may be added.

What is claimed is:

1. An electronic device comprising:
a display;
at least one processor; and
at least one memory configured to store instructions,
wherein the instructions, when executed individually or collectively by the at least one processor, cause the electronic device to:
identify a specific object in an image;
identify at least one movement point of a virtual camera, based on a position of the specific object;
identify a movement trajectory, based on the at least one movement point;
capture a video, based on the movement trajectory; and
display the video on the display and/or store the video in the at least one memory.

2. The electronic device of claim 1, wherein the video comprises a three-dimensional (3D) video, and
wherein the instructions, when executed by the at least one processor, cause the electronic device to identify the specific object in the image by using at least one of a segment engine, a depth heat map, or a saliency learning model.

3. The electronic device of claim 1, wherein the instructions, when executed individually or collectively by the at least one processor, cause the electronic device to identify at least one of a face or a gaze in the specific object.

4. The electronic device of claim 3, wherein the instructions, when executed individually or collectively by the at least one processor, cause the electronic device to identify the at least one movement point comprising a start point, an end point, and a passing point, based on the at least one of the face or the gaze identified in the specific object.

5. The electronic device of claim 4, wherein the instructions, when executed individually or collectively by the at least one processor, cause the electronic device to identify, as the passing point, an intermediate point between the start point and the end point.

6. The electronic device of claim 4, wherein the instructions, when executed individually or collectively by the at least one processor, cause the electronic device to generate, in a 3D space for the image, the movement trajectory which, in a curved trajectory, passes through the start point, the end point, and the passing point.

7. The electronic device of claim 6, wherein the instructions, when executed individually or collectively by the at least one processor, cause the electronic device to generate the curved trajectory, based on a Bezier curve or a cardinal spline.

8. The electronic device of claim 6, wherein the instructions, when executed individually or collectively by the at least one processor, cause the electronic device to control the virtual camera to be directed toward the specific object while moving the virtual camera along the movement trajectory.

9. The electronic device of claim 6, wherein the instructions, when executed individually or collectively by the at least one processor, cause the electronic device to make a capturing time different according to the start point, the end point, and the passing point when capturing the specific object along the movement trajectory in the 3D space.

10. The electronic device of claim 3, wherein the instructions, when executed individually or collectively by the at least one processor, cause the electronic device to, based on multiple objects being included in the image, identify multiple passing points, based on the multiple objects.

11. A three-dimensional (3D) image display method of an electronic device, the method comprising:
identifying a specific object in an image;
identifying at least one movement point of a virtual camera, based on a position of the specific object;
identifying a movement trajectory, based on the at least one movement point;
capturing a video, based on the movement trajectory; and
displaying the video on a display and/or storing the video in at least one memory.

12. The method of claim 11, wherein the video comprises a three-dimensional (3D) video, and
wherein the method further comprises identifying the specific object in the image by using at least one of a segment engine, a depth heat map, or a saliency learning model.

13. The method of claim 11, further comprising identifying at least one of a face or a gaze in the specific object.

14. The method of claim 13, further comprising identifying the at least one movement point comprising a start point, an end point, and a passing point, based on the at least one of the face or the gaze identified in the specific object.

15. The method of claim 14, further comprising identifying, as the passing point, an intermediate point between the start point and the end point.

16. The method of claim 14, further comprising generating, in a 3D space for the image, the movement trajectory which, in a curved trajectory, passes through the start point, the end point, and the passing point.

17. The method of claim 16, further comprising generating the curved trajectory, based on a Bezier curve or a cardinal spline.

18. The method of claim 16, further comprising controlling the virtual camera to be directed toward the specific object while moving the virtual camera along the movement trajectory.

19. The method of claim 16, further comprising, in case of capturing the specific object along the movement trajectory in the 3D space, making a capturing time different according to the start point, the end point, and the passing point.

20. The method of claim 13, further comprising, based on multiple objects being included in the image, identifying multiple passing points, based on the multiple objects.
